(19) United States
(12) Patent Application Publication
(10) Pub. No.: US 2021/0394874 A1
(43) Pub. Date: Dec. 23, 2021

(54) FLOATING HIGH STABILITY OFFSHORE STRUCTURE

(71) Applicant: SLLP 134 LIMITED, Aberdeen Aberdeenshire (GB)

(72) Inventor: Malcolm Bowie, Aberdeen Aberdeenshire (GB)

(21) Appl. No.: 17/292,531

(22) PCT Filed: Nov. 11, 2019
(86) PCT No.: PCT/GB2019/053181

§ 371 Date: May 10, 2021

(30) Foreign Application Priority Data
Nov. 12, 2018 (GB) 1818369.9

(51) Int. Cl. B63B 39/03; B63B 35/44

(52) U.S. Cl. CPC B63B 39/03; B63B 2035/442; B63B 2035/446; B63B 35/44

(57) ABSTRACT

A floating structure in the form of a spar which from a base (12) includes a first ballast weight (16), an entrapped fluid compartment (18), an equipment compartment (20), a second ballast weight (22) and a topside (24) wherein, in use, the structure floats with the water line between the topside and the second ballast weight. The arrangement utilises vertical spacing between physical masses and entrapped fluid to increase the natural period in pitch and roll motions to provide high stability. Embodiments of entrapped fluid compartments are described. The floating structure finds application in hydrocarbon recovery in shallow water and offshore renewables.

The present invention relates to stability in floating structures and in particular, though not exclusively, to a spar structure which utilises vertical spacing between physical masses and entrapped water to increase the natural period in pitch and roll motions to provide high stability.

Floating ocean structures have to have stability against the action of wind, waves and current to prevent excessive motions onboard.

The behaviour of ship shaped structures is well understood and can have particularly large roll motions in certain conditions. In heavy weather the forces on a vessel moored on a fixed heading can give rise to very high mooring loads due in part to high roll motions generating large mooring line dynamics. Therefore; a more complex and expensive turret is usually considered to allow the vessel to weather vane into the weather.

The motions of semi-submersible structures are also well known and these structures can also provide high stability with often a large topsides weight capacity.

The development of small to medium sized offshore structures to carry equipment offshore in a hostile region is particularly challenging and a number of systems have been developed or proposed to address this requirement.

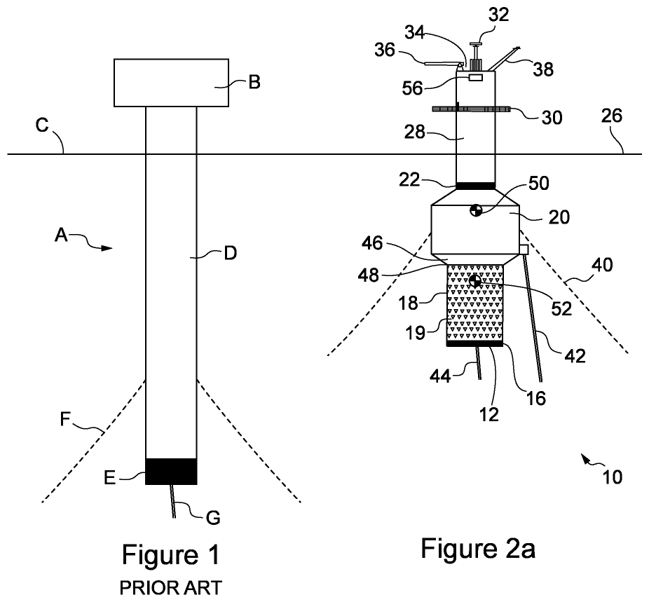

Spar structures are tall cylinders with large counterweights at the bottom and topsides above the water line. FIG. 1 is a typical spar A with the topsides B above the water line C, which contains most of the functionality of the structure, a buoyant section D, together with a heavy ballast weight E at the lowest part of the structure. The system is moored by mooring lines F and fluids and or power pass through the flexible riser G. The spar structure A has a high stability by virtue of the large distance between the centre of gravity and centre of buoyancy.

A disadvantage of the prior art spar is that to achieve the high stability, the water depth required can preclude such a configuration from use in shallow waters, typically less than 150 meters (500 feet).

A further disadvantage is that the equipment is stored in the topsides above the water line and hence are not only exposed to the elements, but adds significantly to the windage area. For very high sea states the topsides is usually high above the water line to avoid wave impact or ‘green’ water damage and hence the overturning moment from wind can be very large. In addition, the motions and accelerations imposed on the equipment by being high above the centre of rotation can place demands on the structural design.

Additionally, the natural period in heave of the traditional spar structure can create fatigue problems due to a small water plane area compared to the displaced volume. Many spars have large “heave plates” or “damping plates” to reduce the resonance at the heave natural period.

WO2017168143A1 discloses a buoy for the processing of production fluids from an offshore well, the buoy comprising a hydrocarbon processing facility adapted to process production fluids received from the offshore well, the hydrocarbon processing facility being submerged below the operating waterline of the buoy, wherein the buoy has a pressure relief channel adapted to relieve pressure within a chamber below the operating waterline of the buoy in the 1event of over-pressurisation within the chamber, the pressure relief channel being in fluid communication with chamber and wherein the pressure relief channel is adapted to vent gas pressure above the operating waterline of the buoy. Equipment is located below the water line and while this is acknowledged as assisting in stability by lowering the centre of gravity, the overall stability of the structure is not considered.

It is an object of the present invention to provide a floating structure which obviates or mitigates at least some of the disadvantages of the prior art.

It is a further object of at least one embodiment of the present invention to provide a spar structure which utilises vertical spacing between physical masses and entrapped water to increase the natural period in pitch and roll motions to provide high stability.

According to a first aspect of the present invention there is provided a floating structure comprising:

a cylindrical body including, in order from a base,

a first ballast weight;

an entrapped fluid compartment;

an equipment compartment;

a second ballast weight; and

a topside;

wherein, in use, the structure floats with the water line between the topside and the second ballast weight.

In this way, a floating structure is provided which utilises vertical spacing between physical masses and entrapped water to increase the natural period in pitch and roll motions; minimising motions at the equipment locations by locating the centre of pitch and roll as close to the equipment location as possible while providing optimisation of centre of buoyancy, gravity and hydrodynamic rotation.

Preferably, the entrapped fluid compartment is sub-divided. In this way, the entrapped fluid will now move with the structure.

The entrapped fluid compartment may be sub-divided into a plurality of vertical cells by locating a plurality of floors in the entrapped fluid compartment. In this way, the entrapped fluid can be mostly entrapped in the horizontal and pitch/roll direction but is largely free to move in the vertical direction.

The entrapped fluid compartment may be sub-divided in a matrix array arrangement. In this way, short term movement of the fluid within the structure is mitigated.

The entrapped fluid compartment may be sub-divided with a plurality of vertically arranged tubes. In this way, the fluid is partially free to move in the heave direction and thus heave dampening can be adjusted. Preferably, the vertical tubes are connected to each other by one or more horizontally arranged plates.

Preferably, the entrapped fluid is water. The entrapped fluid may be sea water. The entrapped fluid may be a fluid with a viscosity greater than that of water. This may be achieved by use of a gel or additives. In this way, the entrapped volume of fluid is a high viscosity medium, either by nature or by design, which reduces the need for extensive sub-division which increases the rotational inertia of the structure at the periods associated with ocean waves.

Preferably, the structure is formed in two parts: a first part including the first ballast weight and entrapped fluid compartment; and a second part including the equipment compartment, a second ballast weight and topside. In this way, the structure can be constructed in the same orientation as its final use.

In an embodiment, the floating structure is a spar including an offshore hydrocarbon production facility. In this way, oil production in shallow water is achievable.

In an alternative embodiment, the floating structure is a spar including either a vertical or horizontal axis wind turbine. In this way, the structure can use the inertia of water to stabilise a floating wind turbine support structure.

Accordingly, the drawings and description are to be regarded as illustrative in nature and not as restrictive. Furthermore, the terminology and phraseology used herein is solely used for descriptive purposes and should not be construed as limiting in scope languages such as including, comprising, having, containing or involving and variations thereof is intended to be broad and encompass the subject matter listed thereafter, equivalents and additional subject matter not recited and is not intended to exclude other additives, components, integers or steps. Likewise, the term comprising, is considered synonymous with the terms including or containing for applicable legal purposes. Any discussion of documents, acts, materials, devices, articles and the like is included in the specification solely for the purpose of providing a context for the present invention. It is not suggested or represented that any or all of these matters form part of the prior art based on a common general knowledge in the field relevant to the present invention. All numerical values in the disclosure are understood as being modified by “about”. All singular forms of elements or any other components described herein are understood to include plural forms thereof and vice versa.

Embodiments of the present invention will now be described, by way of example only, with reference to the accompanying Figures, of which:

FIG. 1 is schematic illustration of a prior art spar floating structure;

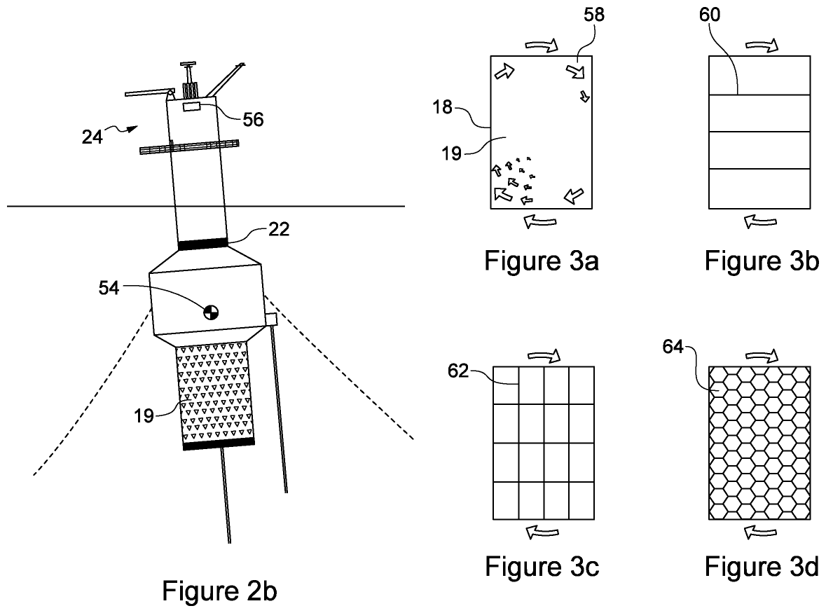

FIGS. 2(a)-(b) are schematic illustrations of a floating structure according to an embodiment of the present invention indicating (a) the centre of buoyancy and centre of gravity; and (b) the centre of rotation;

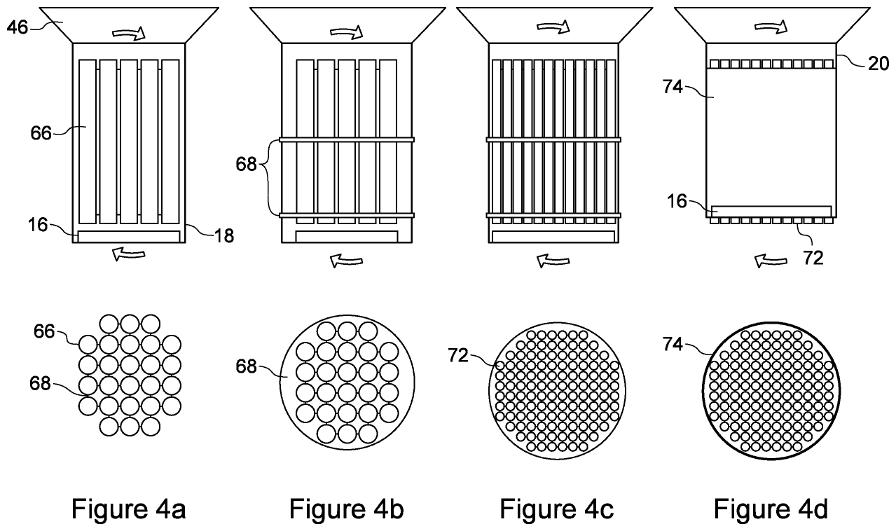

FIGS. 3(a)-(d) illustrate different embodiments of entrapped fluid compartments with (a) open compartment; (b) sub-divided into vertical cells; (c) sub-divided into horizontal and vertical cells; and (d) sub-divided into a honeycomb arrangement;

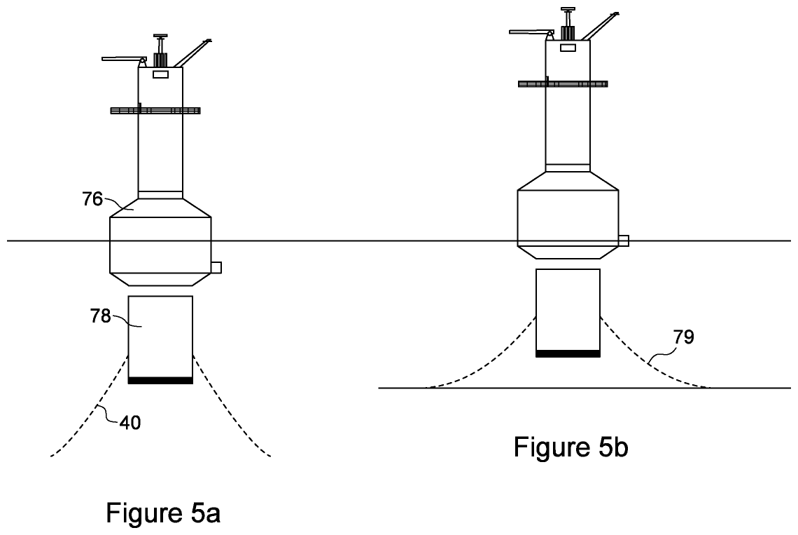

FIGS. 4(a)-(d) illustrate further embodiments of entrapped fluid compartments with (a) vertical tubes; (b) vertical tubes with horizontal plates; (c) smaller vertical tubes; and (d) vertical tubes arranged at ends of an entrapped fluid compartment;

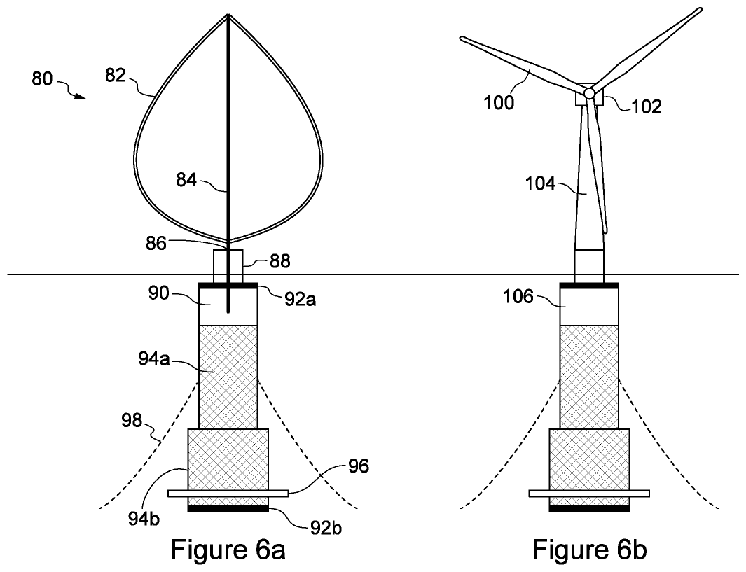

FIGS. 5(a)-(b) illustrate the floating structure of FIG. 2(a) being constructed in two parts at (a) a field location and (b) in shallower water with the upper section being floated to meet the lower section prior to towing to location; and

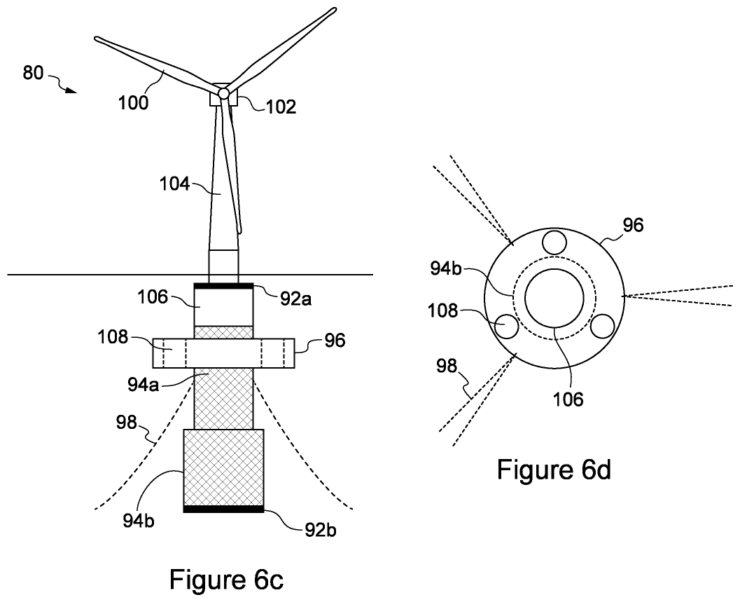

FIGS. 6(a)-(d) are schematic illustrations of a floating structure being a spar supporting a vertical axis wind turbine according to a further embodiment of the present invention.

Reference is initially made to FIGS. 2(a) and 2(b) of the drawings which illustrate a floating structure, generally indicated by reference numeral 10, according to an embodiment of the present invention. Floating structure 10 is a spar having arranged from a first end or base 12 of a cylindrical body 14, a first ballast weight 16, an entrapped fluid compartment 18, an equipment compartment 20, a second ballast weight 22 and a topside 24, with the topside 24 being above the water level 26 and all other parts below.

Floating structure 10 provides a not normally manned buoy for subsea hydrocarbon production which contains the majority of the functional equipment below the waterline in compartment 20 and is accessed via the shaft from the landing deck 30. The communication and vents 32 are located on the top deck 34 together with the crane 36 and flare 38 as required for the application. The structure 10 is moored by mooring lines 40 and power and/or fluids to seabed is through the flexible risers 42 and 44. The keel 46 of the main structure is at the bottom 48 of the equipment compartment 20, which is where ballast weight would normally be located in a traditional buoy/spar configuration. The entrapped fluid 19, being water, is located in space 18 and the main ballast weight 16 is at the bottom 12 of the structure 10.

The current design methods for a spar shaped structure is principally focused around maximising the distance between the centre of buoyancy and the centre of gravity of the structure to maximise the stability. It is recognised that there are two types of stability, namely;
Static stability or the resistance to a structure tilt for an applied external horizontal load; and
Dynamic stability being the natural period of a structure and magnitude of damping of such motion.

The centre of gravity is chosen so as to give the structure 10 sufficient static and intact stability, based on the location of the centre of buoyancy. However; the distribution of mass via is chosen so as to maximise the inertia of the structure in the roll and pitch axes. This increases the natural period in pitch and roll to well beyond that of the waves commonly found in the open ocean.

The distribution of mass is performed in two principal methods. One of the methods is by having a large ballast mass as low down into the structure as practical, generally well below the equipment space, but also having ballast masses higher up into the structure which not only increase the structure roll and pitch inertia by being far apart, but also adjust the centre of gravity and centre of rotation to the optimal position. This is illustrated in FIG. 2(a) where the large ballast mass is the first ballast weight 16 and the centre of buoyancy 50 and centre of gravity 52 are marked.

The other method is utilising the rotational inertia of additional mass provided between the lower mass and the equipment space which is usually entrapped fluid, which may be seawater, as illustrated in FIG. 2(b). If the entrapped fluid is free to move internally as the structure rotates the increase in rotational inertia will be low, plus the fluid may move out-of-phase. By compartmentalising and restricting the fluid particles from moving under the action of pitch and roll the rotational inertia can be significantly increased without directly affecting the position of the centre of gravity of the structure. The centre of rotation 54 is now marked. In FIG. 2(b), the not normally manned buoy, structure 10, is in a tilted position around the centre of hydrodynamic rotation 54 illustrating the rotational motion of the entrapped water 19. To achieve the increase in rotational inertia a second ballast weight 22 is located higher up the structure 10 above the equipment compartment 20 but still below the water level 26. In additional optionally a smaller tertiary ballast weight 56 may be located towards the top of the structure 10 in the topside 24. The tertiary weight takes advantage of the physical principle that the moment of inertia increases with the square of the distance, whereas the centre of gravity uses the distance only.

This provides a high stability floating spar structure to carry equipment onboard in a climate controlled environment. This is by use of an enclosed space below the waterline to carry the equipment. This also results in a structure with a small windage area from the minimal topsides which is subject to significantly reduced overturning moments than if all the equipment was well above the waterline. In addition with the equipment being located nearer the centre of rotation under the water the acceleration forces on the equipment are significantly reduced. The invention presented can be used not only in extremely hostile conditions but in water depths less than for a traditional spar structure i.e. shallow water.

The section of the structure 10 below the water line can also be used as additional space for oil storage and LP separation with storage of between 10,000-50,000 barrel possible, utilising the oil as the entrapped fluids for the purposes of dynamic inertial stability.

Referring now to the fluid entrapped compartment 18, this represents an enclosed volume. If this volume of seawater is in a single space, a significant proportion of the water will not pitch and roll with the structure but will move around in a turbulent manner, or not at all (for example in the central part) and hence not have optimal efficiency in creating roll/pitch inertia as illustrated in FIG. 3(a). FIG. 3(a) illustrates the typical flow 58 of entrapped water 19 around an enclosed volume where the fluid resistance to rotation creates a complex flow path around the internals.

If the compartment 18 is compartmentalised, more of the entrapped water 19 is likely to move with the structure 10, increasing the natural period of the structure and hence the dynamic stability. In one form of this the compartment 18 is sub-divided into a number of vertical cells in which the water will tend to move with the structure. This can be improved in accordance with FIG. 3(b) by placing a number of floors 60 within the compartment 18 to sub-divide the compartment 18 and increase the amount of water that moves with the structure, rather than move in a turbulent manner. The provision of the deck levels 60 to restrict flow of water 19 during rotation, increases the whole structures rotational inertia.

FIG. 3(c) illustrates the provision of vertical walls 62 to further restrict flow of water during rotation further increasing the whole structure 10 rotational inertia.

FIG. 3(d) shows an alternative configuration utilising a honeycomb 64 or sponge material to mitigate short term movement of water within the structure by utilising the non-compressible nature of seawater to prevent movement. The honeycomb structure 64 encapsulates the majority of the entrapped water. Such a structure does not need to be completely watertight between each honeycomb cell; since the resistance to flow will increase the rotational damping effect of the water 19. The honeycomb matrix is for illustrative purposes only and the structure can be any matrix array which performs a function of restricting movement of the entrapped fluid.

An alternative to this for smaller structures is to use a gel or add compounds which increase the viscosity of the fluid contained within, reducing the need for extensive compartmentalisation.

FIG. 4(a) shows an alternative configuration to maximise the rotational inertia of the water using vertical tubes 66 to contain the water 19. The arrangement of vertical tubes 66 allow water 19 to pass through vertically but rotate with the structure, including the water enclosed within the tubes. The lower ballast weight 16 is typically underneath the tube arrangement. The tubes 66 can be interconnected via plate elements 68 to form a rigid structure, as shown in FIG. 4(b). Thus, the gaps between the cylinders 66 can be either open in the vertical direction or closed off via horizontal plate 68 to affix the cylindrical tubes 66 together. The tubes 66 and ballast weight 16 is supported by a structural arrangement 18 below the keel 46 at the bottom of 40 of the equipment compartment 20, as illustrated in FIG. 2(a). This also has the added benefit that the water is partially free to move in the heave direction. The heave response of the structure can therefore be tuned by altering the resistance to flow by adjusting the length and diameter of the tubes and hence the heave dampening can also be adjusted to suit the particular application. This addresses some of the design response concerns of a traditional spar where there is a large mass relative to the water plane area.

FIG. 4(b) illustrates the use of two heave plates 68 which increase the heave damping of the structure plus provide structural rigidity to the tube 66 arrangement. The heave plates 68 may be connected to the walls 70 of the entrapped fluid compartment 18 for additional rigidity.

FIG. 4(c) illustrates a larger number of smaller vertical tubes 72 used to form the vertical tube array.

FIG. 4(d) illustrates the use of a cylindrical structure 74 around the vertical tubes 72 to further increase the structural rigidity. The vertical tubes 72 protrude above and below the cylindrical structure. The vertical tubes also pass through the first ballast weight 16. The cylindrical structure 74 is located inside or as an integral part of the compartment 18 and may be directly connected to the keel 46.

The dimensions of the tubes 66,72 can therefore be adjusted to tune the structure response. In addition the vertical tubes 66,72 can allow the water to pass vertically through the structure reducing the vertical inertial mass, but retaining most of the roll/pitch rotational mass. Additionally the ends of the tubes can be capped with a plate with a hole smaller than the inside diameter of the tubes, forming an orifice plate, to further tune the system response.

FIG. 5(a) illustrates the typical not normally manned buoy as shown in FIG. 2(a) in two parts, the main structure 76 and the spar ballast and inertial damper section 78. The main structure 76 comprises the topside 24, second ballast weight 22, equipment compartment 20 and keel 46. The spar ballast and inertial damper section 78 comprises the first ballast weight 16 and the entrapped fluid compartment 18. This arrangement allows the installation of the ballast and inertial damper section 78 in the field by attaching it to the mooring lines 40 prior to the main structure 76 arrival. The connection of the two sections 76,78 can be achieved by ballasting either or both structures to match together. The sections 76,78 can be fixed together in a number of means using prior art such as bolting or clamps or if one or more internal compartments can be evacuated of water a welded connection. The watertight integrity of this seal is not critical, since the inside and outside of the connection is open to the seawater.

FIG. 5(b) illustrates a further variation where the water depth is shallow and the main structure 76 is floated out with a smaller draught. The ballast and inertial damper section 78 is connected to temporary mooring lines 79. This is typically used for matching the two sections 76,78 prior to towing to field.

A spar structure divided into two discrete sections, namely the functional upper section 76 and the lower ballast/inertial damper section 78, allows fabrication of the two sections 76,78 in parallel in the final orientation, simplifying the fabrication and commissioning.

The application for a floating structure according to the present invention can be extended into the field of offshore renewables, principally but not limited to vertical axis wind turbines, which currently do not have an ideal supporting structure which lends itself to the turbine characteristics. The vertical axis wind turbine requires a heavy mass generator low down into the structure and bearing also at the topsides, to which the flexibility in the weight distribution and natural period offered by the present floating structure may accelerate the development of this technology.

FIG. 6(a) illustrates a Vertical Axis Wind Turbine, generally indicated by reference numeral 80, according to an embodiment of the present invention. Turbine 80 has two or three blades 82 illustrated together with the central support column 84. The column extended into the topsides access platform 88 through a bearing 86 and into the generator compartment 90. The static stability of the structure is provided by the buoyancy of the generator compartment, representing the equipment compartment 20 in structure 10, and the ballast weights 92a and 92b, representing second 22 and first 16 ballast weights respectively. The dynamic stability is further enhanced by the entrapped water in the compartments 94a and 94b equivalent to the entrapped fluid compartment 18 in the structure 10. The compartment 94b has a greater diameter to increase the volume and hence inertia and is located further down out of the majority of wave action. An optional heave plate 96 has been provided which is low down in the water clear of the mooring lines 98. The application can also be applied to a horizontal axis wind turbine as illustrated in FIG. 6(b). The turbine has three blades 100 affixed to the nacelle and generator 102, supported by the tower 104. The compartment 106 which is normally used for switchgear, transformer and power cable termination as required.

With reference to FIG. 6(c), the entrapped water can also be used within a heave plate 96 to both dampen rotational and heave motions out but also increase the rotational moment of inertia of the structure by being placed in the vertical axis closer to the centre of rotation of the overall assembly 80. The compartmentalisation of the heave plate also lends itself to provision of ballast tanks 108, which can be used to provide fine control over the trim and angle of the spar, by adjusting the amount of air inside.

FIG. 6(d) shows a plan view of the assembly 80, from the waterline downward, showing the typical locations of the ballast tanks on a diameter around the centre axis of the assembly.

The principle advantage of the present invention is that it provides a high stability floating structure which not only compromises between the static and dynamic stability but also adjusts the centre of rotation to be as close as practical to the equipment location, thus minimising structural fatigue and improving operational performance. This therefore means that the invention introduces the concept of optimisation of centre of buoyancy, gravity and hydrodynamic rotation.

To achieve the dynamic stability the placing of ballast weight higher up in the structure is contrary to the spar concept; however, providing the weight does not affect the minimum static stability criteria it increases the dynamic stability significantly, together with adjusting the centre of rotation in pitch and roll.

The other aspect which further improves the stability is by mobilising the inertia of the trapped water within the lower part of the spar structure. Whilst this increases the horizontal hydrodynamic load due to the greater added mass this can be offset by significantly reduced wave frequency motion, which can be a significant driver for mooring design. The position of the entrapped water also allows adjustment of the centre of hydrodynamic rotation without affecting the centre of gravity of buoyancy, since the entrapped water has the same density as the ocean.

The concept of having vertical tubes to contain this water allows them to contribute significantly to the pitch and roll inertia but minimising the inertial mass in the vertical direction, but more importantly allow significant design flexibility in adjusting the natural period plus dampening out the heave motions associated with spar structures. Selected vertical tubes can alternatively be used as trimming or ballast compartments to maintain the verticality of the structure in operation.

Combining both the tubes and a heave plate at a location close to the centre of rotation of the assembly not only maximising the rotational inertia, rotational damping but also allows adjustment of the angle of the spar structure in response to changing loads and weather conditions, which is a significant benefit for the floating offshore wind industry.

Together with the equipment being located below the waterline in a void space otherwise largely given over to buoyancy for a normal spar design and the lack of topsides windage area, this allows for a spar design which has exceptionally high stability and sea keeping characteristics. In addition due to the lower centre of gravity, due to absence of large topsides, the depth of the ballast mass can be significant shallower, allowing the system to be used in significantly shallower water than a traditional spar, for example, in the North Sea.

The invention also allows fabrication of the spar in the orientation of its final use (i.e. vertical), where-as most spars have to be fabricated horizontally and then rotated in-field. This allows significantly greater flexibility for construction and allows greater onshore commissioning of equipment and loading of the facility.

1. A floating structure comprising:
a cylindrical body including, in order from a base,
a first ballast weight;
an entrapped fluid compartment;
an equipment compartment;
a second ballast weight; and
a topside;
wherein, in use, the structure floats with the water line between the topside and the second ballast weight.

2. The floating structure according to claim 1 wherein the entrapped fluid compartment is sub-divided.

3. The floating structure according to claim 2 wherein the entrapped fluid compartment is sub-divided into a plurality of cells by locating a plurality of floors horizontally in the entrapped fluid compartment.

4. The floating structure according to claim 2 wherein the entrapped fluid compartment is sub-divided in a matrix array arrangement.

5. The floating structure according to claim 2 wherein the entrapped fluid compartment is sub-divided with a plurality of substantially vertically arranged tubes.

6. The floating structure according to claim 5 wherein the vertical tubes are connected to each other by one or more horizontally arranged plates.

7. The floating structure according to claim 1 wherein the entrapped fluid is water.

8. The floating structure according to claim 7 wherein the entrapped fluid may be sea water.

9. The floating structure according to claim 1 wherein the entrapped fluid is a fluid with a viscosity greater than that of water.

10. The floating structure according to claim 9 wherein the entrapped fluid is a gel.

11. The floating structure according to claim 9 wherein the entrapped fluid is water with additives.

12. The floating structure according to claim 1 wherein the structure is formed in two parts: a first part including the first ballast weight and entrapped fluid compartment; and a second part including the equipment compartment, a second ballast weight and topside.

13. The floating structure according to claim 1 wherein entrapped fluids are contained within a heave plate, close to a centre of rotation of the structure.

14. The floating structure according to claim 1 wherein subsea ballast tanks are used on a pitch diameter close to a centre of rotation of the structure in order to adjust an angle of the structure.

15. The floating structure according to claim 1 wherein the floating structure is a spar including an offshore hydrocarbon production facility.

16. The floating structure according to claim 1 wherein the floating structure is a spar including a vertical axis wind turbine.

17. The floating structure according to claim 1 wherein the floating structure is a spar including a horizontal axis wind turbine.
